(19) United States
(12) Patent Application Publication
(10) Pub. No.: US 2017/0278422 A1
(43) Pub. Date: Sep. 28, 2017

(54) Multi Fastener Dressing Apron

(71) Applicant: Michelle Allen LaPointe, Brookline, MA (US)

(72) Inventor: Michelle Allen LaPointe, Brookline, MA (US)

(21) Appl. No.: 15/468,445

(22) Filed: Mar. 24, 2017

Related U.S. Application Data
(63) Continuation-in-part of application No. 62/312,517, filed on Mar. 24, 2016.

(51) Int. Cl. G09B 19/00; A41F 9/02; A41D 27/20; A41D 13/04

(52) U.S. Cl. CPC G09B 19/0076; A41D 13/04; A41F 9/025; A41D 27/20; A41D 2300/33; A41D 2300/322

(57) ABSTRACT

A wearable dressing device for teaching children and adults with special needs to independently manipulate (fasten and unfasten) clothing fasteners that are correctly positioned at the waist. The dressing device resembles an apron and comprises a variety of clothing fasteners. It is an improved dressing device in that the fasteners are positioned in the same spot on the dressing device as they would be positioned on a lower body article of clothing, such as pants, shorts, or a skirt, thereby making the acquired dressing skill generalizable to the aforementioned lower body items of clothing.

### BACKGROUND OF THE INVENTION

The present embodiment relates to the field of rehabilitation within the population of pediatrics and adults with special needs. Special needs include various physical, developmental, and/or cognitive impairments. These impairments can manifest in the following ways: poor attention span, poor visual-perception, poor proprioceptive awareness, low muscle tone, poor postural control, muscle weakness, tactile defensiveness, poor body awareness, poor dexterity, difficulty with sequencing tasks, poor bilateral coordination, and poor motor planning. Independently completing self-care tasks such as dressing tasks, can be problematic for children and adults with special needs due to the impairments set forth above. One type of dressing task that this population is likely to have difficulty with is the manipulation (fastening and unfastening) of clothing fasteners. For example, dressing tasks involving the manipulation of clothing fasteners include, but are not limited to buttoning and unbuttoning pants, zipping and unzipping pants, lacing and unlacing a belt through belt loops, and fastening and unfastening a belt buckle. Experiencing difficulty with the manipulation of clothing fasteners, can therefore impact the ability to independently get oneself dressed and undressed. The present embodiment serves to solve this problem.

Currently, there are wearable and non-wearable dressing devices that exist to help children and adults with special needs learn to manipulate clothing fasteners. However, there are currently no wearable dressing devices that exist to help this population learn to manipulate clothing fasteners that are positioned at the waist, with correct orientation to the body. The wearable dressing devices that exist typically include vests and aprons. For example, there are several different dressing vests that include clothing fasteners such as zippers, buttons, and snaps. The vests are meant to be worn over the person's clothing so that the dressing skills can be practiced anywhere. The disadvantage to the vests is that they only enable the person to learn to manipulate upper body clothing fasteners; those found on shirts and coats (e.g.). They do not enable the person to learn to manipulate lower body clothing fasteners; those found on pants, shorts and skirts (e.g.). There are also wearable apron like devices that aim to teach the manipulation of clothing fasteners. However the fasteners on these devices are not arranged in a position that one would find on a lower body article of clothing; rather they are arbitrarily placed (e.g. fasteners are positioned off to either side of the device, toward the bottom of the device, or they are crowded together). These apron like devices also have clothing fasteners affixed to them that are irrelevant to lower body clothing items (e.g. horizontally placed zipper, a lacing pattern, a strip of three consecutive large buttons, etc). It does not make sense to practice zipping and unzipping a horizontal zipper since lower body clothing typically does not incorporate horizontal zippers; rather they are vertical zippers. Likewise, it does not make sense to practice lacing a string as this is typically not something you would need to do on a lower body article of clothing. Lastly, it does not make sense to practice buttoning and unbuttoning 3 large consecutively placed buttons, as this would unlikely be incorporated into a lower body article of clothing. These examples of arbitrarily placed clothing fasteners are not helpful in facilitating independence with the manipulation of clothing fasteners on lower body articles of clothing for the target population. There are also non-wearable dressing devices that exist that aim to teach the manipulation of clothing fasteners to children. These dressing devices include inanimate objects such as dolls, stuffed animals, and pillows. These dressing devices also have arbitrarily placed clothing fasteners. One disadvantage of these items is that they are only geared toward children. A second disadvantage is that these items are not worn on the body. When the item isn't worn on the body, the child may only learn to manipulate the clothing fastener on the item itself, and not demonstrate the same skill on an article of clothing while it is worn on the body. The clothing fasteners on the inanimate objects are not oriented to the child's body as they would be on a typical article of lower body clothing. Therefore, the dressing skills will often not generalize to actual articles of clothing when worn on the body. Thus, the child will not acquire independence with this dressing task within the context of a dressing routine. Currently, there are no wearable dressing devices that exist to help children and adults with special needs learn to manipulate clothing fasteners that are positioned at the waist, with correct orientation to the body. With regards to the prior art, there is a need for a wearable dressing device that can be worn over clothing, that will enable children and adults with special needs to learn to manipulate clothing fasteners that are positioned at the waist (e.g. pants button, pants zipper, belt, etc), while the clothing fasteners are arranged in a manner that would resemble a lower body article of clothing, such as pants, shorts, or skirts. The present embodiment will provide children and adults with special needs with the means to learn to manipulate clothing fasteners that are positioned at the waist, while the clothing fasteners are accurately oriented to the learner's body, thereby simulating a lower body article of clothing, such as pants, shorts, or skirts.

### BRIEF SUMMARY OF THE INVENTION

The objective of the present invention is to serve as a training device to help teach children and adults with special needs to manipulate clothing fasteners that are located at the waist (e.g. pants button, pants zipper, belt, etc). While wearing the dressing device, the clothing fasteners are correctly oriented to the person's body in the same manner as they would be when wearing a lower body article of clothing, such as pants, shorts, or a skirt.

There are several advantages of the present embodiment in comparison to the prior art. One advantage is that the present embodiment simulates a lower body article of clothing in terms of the type of clothing fastener affixed to the device, as well as the position of each clothing fastener on the device. Another advantage of the present embodiment is that children and adults with special needs are able to wear the dressing device around their waist so that the clothing fasteners are correctly oriented to the body in terms of the position they would be found on lower body articles of clothing when worn on the body (e.g. the button is positioned on the top and in the center of the garment to simulate a pants button; the zipper is positioned vertically and directly underneath the button to simulate a pants zipper). Additional advantages of the present embodiment are that it provides the opportunity for this population to work on lower body clothing fasteners by it being a small portable item that can be used in the classroom, at home, or in a therapeutic environment. The child or adult can wear it over their current clothing, therefore they do no not need to wear clothing that contains a fastener just so the fastener can be practiced in therapy or school on that particular day. The device ties around the waist with apron strings, thereby fitting various sized people. The present embodiment is appropriate for use by children and adults. The color of each clothing fastener differs from the colors of the other clothing fasteners, thereby making it easier to distinguish one clothing fastener from the other. The clothing fasteners are of a contrasting color in comparison to the color of the main panel, in order to make it easier to see where to grasp and hold each part of the fastener. Further advantages of the present embodiment include an easily accessible zipper in that there is no overlaying fabric as one would typically find on a lower body article of clothing. The placement of the device when used for training purposes can vary in that it can be used on a table top surface, on the learner's lap, worn loosely around the learner's waist, or worn snug around the learner's waist, wherein the orientation of the fasteners to the body remains relatively the same. This variation in the placement of the device for training purposes can be used to accommodate the learner's current level of performance. For example, the present embodiment can be placed on a tabletop surface so that the clothing fasteners are directly at the learner's midline and directly in the learner's field of vision. When the device is used tabletop, it can also be oriented to the learner's body by placing it so that the top side is closest the learner's body. In this orientation, it will enable the learner to visualize which hand manipulates the various parts of each clothing fastener (e.g. the right hand holds the zipper tab while the left hand holds the bottom of the zipper), visualize how each clothing fastener operates (e.g. the button goes through the buttonhole), and easily observe a demonstration of the device, which may be given by persons such as educators, therapists, or parents. The present embodiment can then be transferred to the learner's lap where clothing fasteners are practiced in a manner that is more difficult than a tabletop placement, but more oriented to the learner's body and more closely resembling an article of clothing when worn on the body. Once skills are learned with the device on the lap, it can then be tied loosely around the waist.

When the device is tied loosely around the waist, the learner is able to practice the clothing fasteners while the device is worn on the body, however the learner can see their hands manipulating the clothing fastener because the device can be pulled away from the person's waist, allowing it to be in their line of sight. Once the clothing fasteners are learned while the device is worn loosely around the waist, the device can then be tied snug around the waist to simulate an article of clothing, where vision is sometimes occluded while manipulating clothing fasteners, and the learner must rely more on their proprioceptive awareness and sense of touch. Overall, the advantages of the present embodiment allow for ease of use and diversity of use while learning to manipulate clothing fasteners located at the waist.

### BRIEF DESCRIPTION OF THE SEVERAL VIEWS OF THE DRAWING

FIG. 1 shows an anterior view of the present embodiment with every element of the present embodiment visible.

FIG. 2 shows an anterior view of the present embodiment with each clothing fastener (button and corresponding button flap, belt, belt buckle, and zipper) in an unfastened position; and apron ties untied.

FIG. 3 shows an anterior view of the present embodiment with the belt loops and corresponding belt unlaced; the belt buckle unfastened; the button and corresponding button flap fastened; and the zipper fastened.

FIG. 4 shows an anterior view of the present embodiment with the belt laced through the belt loops; the belt buckle fastened; the zipper fastened; and apron ties untied.

FIG. 5 shows an anterior view of the present embodiment with all clothing fasteners in a fastened position and the apron strings tied together on the posterior side.

FIG. 6 shows a posterior view of the present embodiment with the apron strings tied together on the posterior side.

### DRAWINGS—REFERENCE NUMERALS

11 Main panel
13 Button
15-1 Right side apron string
15-2 Left side apron string
17 Right upper corner
19 Left upper corner
21 Button flap
23 Left side pocket
25 Buttonhole
27 Right side pocket
29 Seam
33-1 Right side belt loop
33-2 Right side belt loop
33-3 Right side belt loop
33-4 Left side belt loop
33-5 Left side belt loop
33-6 Left side belt loop
35 Left side belt
37 Right side belt
39 Belt buckle holes
41 Belt buckle
43 Zipper
45 Top left side edge
47 Top side of the main panel
49 Distal end of the left side belt
51 Top right side edge
53 Distal end of the right side belt
55 Prong

### DETAILED DESCRIPTION OF THE INVENTION

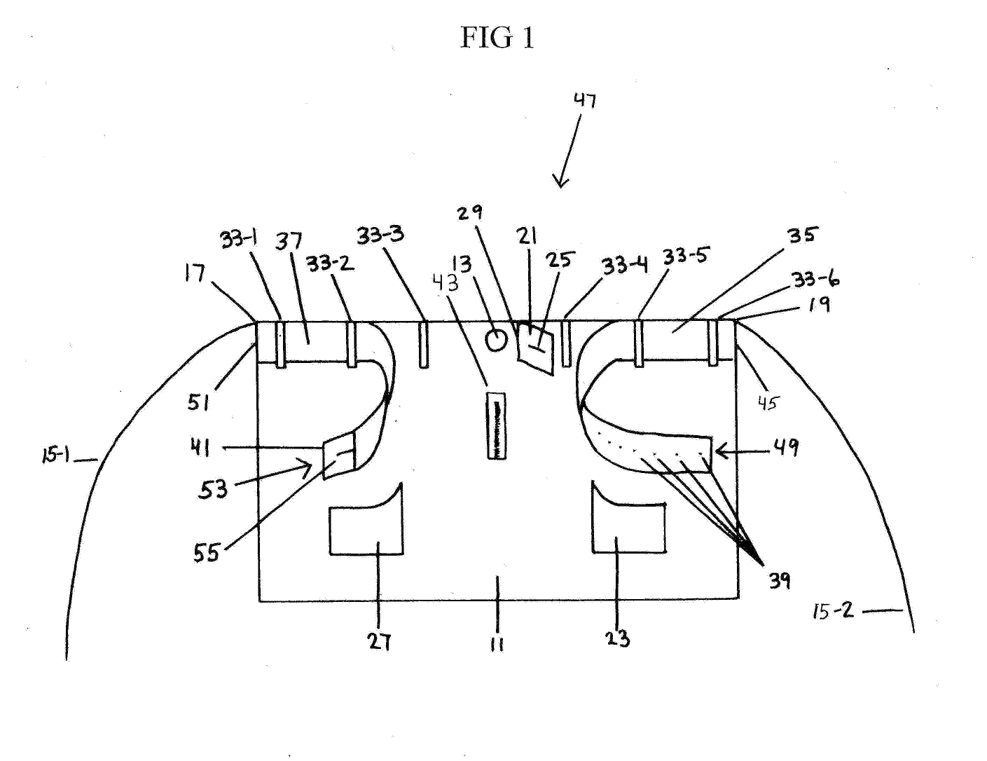

FIG. 1 is an anterior view of the present embodiment. The present embodiment resembles an apron that ties around the waist and covers a portion of the body below the waist. The placement of the elements that make up the present embodiment will henceforth be described in anatomical terms, where “left” refers to a person's left side of their body and “right” refers to a person's right side of their body; and “left” refers to the left side of the present embodiment when worn on the body correctly, and “right” refers to the right side of the present embodiment when worn on the body correctly. The present embodiment comprises a rectangular main panel 11 with a right side apron tie 15-1 that attaches at the right upper corner 17 of the main panel 11 and a left side apron tie 15-2 that attaches at the left upper corner 19 of the main panel 11. In the center of the top side 47 of the main panel 11 is a single button 13. On the left side of the button 13 is a rectangular piece of fabric, referred to as a button flap 21, which comprises a horizontal buttonhole 25. The button flap 21 attaches to the main panel 11 by way of a seam 29 on the left side of the button 13. There are six belt loops 33-1, 33-2, 33-3, 33-4, 33-5 and 33-6 spaced evenly apart along the length of the top side 47 of the main panel 11, with three right side belt loops 33-1, 33-2, 33-3 and three left side belt loops 33-4, 33-5 and 33-6 on either side of the button 13. The belt comprises a left side belt 35 and a right side belt 37. The left side belt 35 is sewn onto the main panel 11 along the proximal edge of the belt and attaches to the top left side edge 45 of the main panel 11. The left side belt 35 contains a plurality of belt buckle holes 39, spaced evenly apart and located at the distal end of the left side belt 49. The right side belt 37 is sewn onto the main panel 11 along the proximal edge of the belt and attaches to the top right side edge 51 of the main panel 11. The distal end of the right side belt 53 comprises a belt buckle 41. The belt buckle 41 affixes to the distal end of the right side belt 53 and comprises a prong 55 that sticks into a belt buckle hole 39 on the left side belt 35, securing the two distal ends of the belt 49 and 53. The zipper 43 is located directly under the button 13 in a vertical manner. The bottom portion of the main panel 11 comprises a left side pocket 23 and right side pocket 27. The components to the present embodiment are each a solid color yet differ from each other in color, in order to provide visual contrast to the learner.

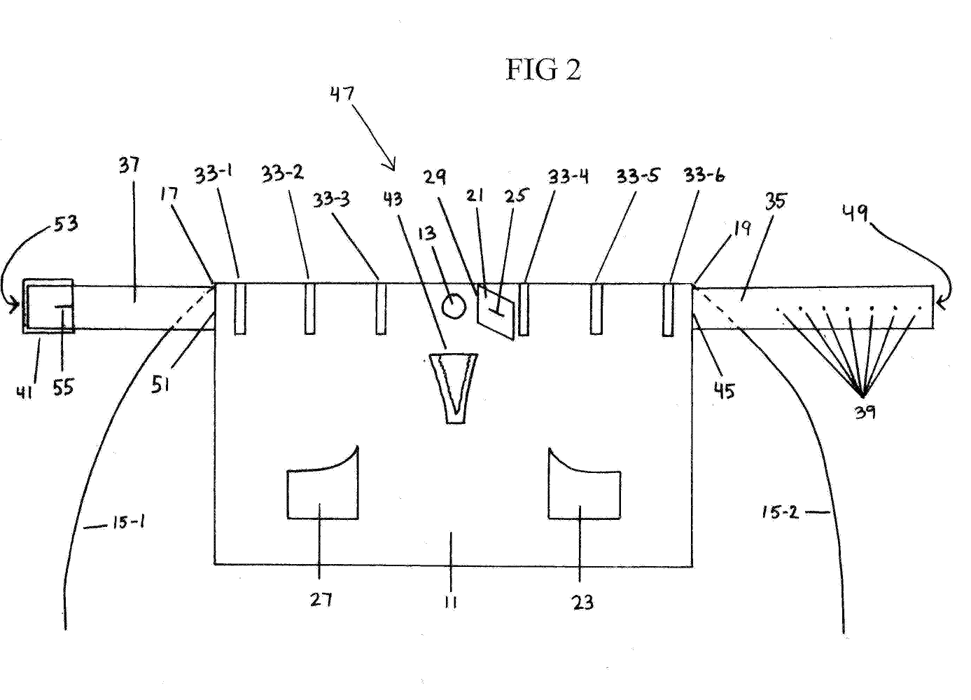

FIG. 2 is an anterior view of the present embodiment. In this view it can be seen that the left side belt 35 and right side belt 37 are unlaced from their corresponding belt loops 33-4, 33-5, 33-6 and 33-1, 33-2, 33-3 (respectively). The learner can practice lacing and unlacing the belt without it coming detached from the main panel 11. This prevents it from getting misplaced and keeps it aligned with the belt loops 33-1, 33-2, 33-3, 33-4, 33-5, and 33-6. The learner can also practice unfastening the belt. The belt and belt loops 33-1, 33-2, 33-3, 33-4, 33-5, and 33-6 are positioned on the main panel 11 in a spot that simulates the location they would be found on a typical lower body article of clothing, such as pants, shorts, or a skirt. In this view it can be seen that the zipper 43 is unzipped. The zipper 43 is free of any overlaying fabric that one may typically encounter on a lower body article of clothing, thereby making it visible to the learner and easily accessible by either hand. The zipper is positioned on the main panel 11 in a spot that simulates the location it would be found on a typical lower body article of clothing, such as pants, shorts, or a skirt.

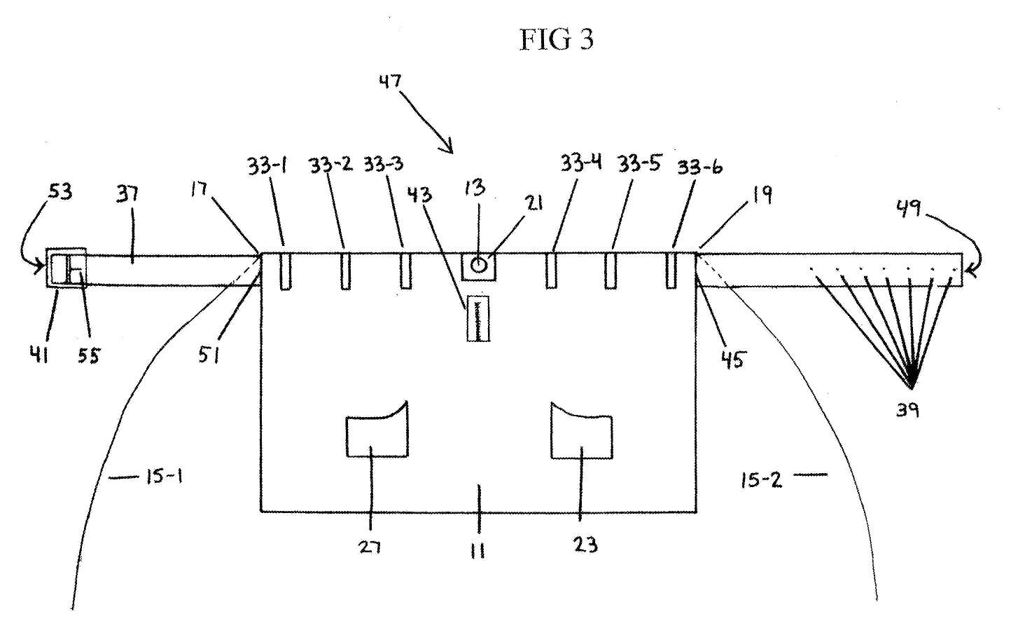

FIG. 3 is an anterior view of the present embodiment. In this view it can be seen that the button 13 and corresponding buttonhole 25 are fastened. The button flap 21 attaches to the main panel 11 by way of a seam 29 on the left side of the button 13. This allows the button flap 21 to be placed directly over the button 13 to be buttoned as shown in FIG. 3. The location of the button flap 21, simulates the orientation of the buttonhole 25 in relation to the button 13 as it would be found on a typical lower body article of clothing. In this view it can be seen that the left side pocket 23 and right side pocket 27 are positioned in a location that a pocket would be found on the anterior side of a lower body article of clothing, thereby simulating a lower body article of clothing such as pants, shorts, or a skirt.

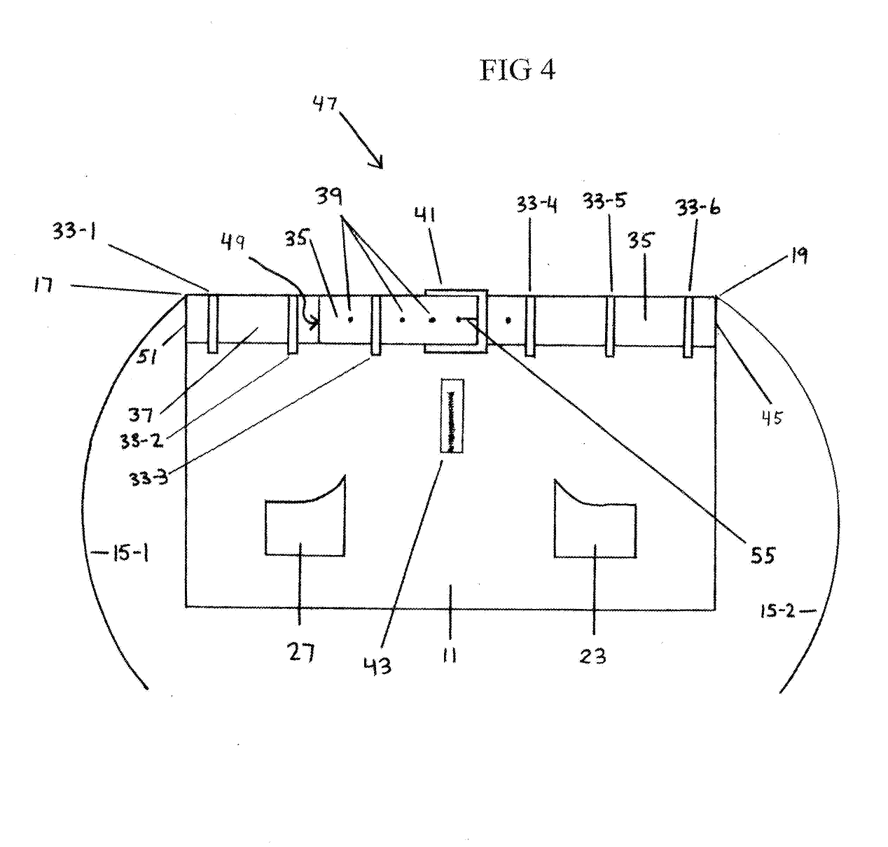

FIG. 4 is an anterior view of the present embodiment. In this view it can be seen that the left side belt 35 and right side belt 37 are laced through their corresponding belt loops 33-4, 33-5, 33-6 and 33-1, 33-2, 33-1 (respectively) and the belt buckle 41 is fastened. In this view it can be seen that the belt is fastened over the button 13 as it would be on a typical lower body article of clothing, thereby simulating a lower body article of clothing such as pants, shorts, or a skirt.

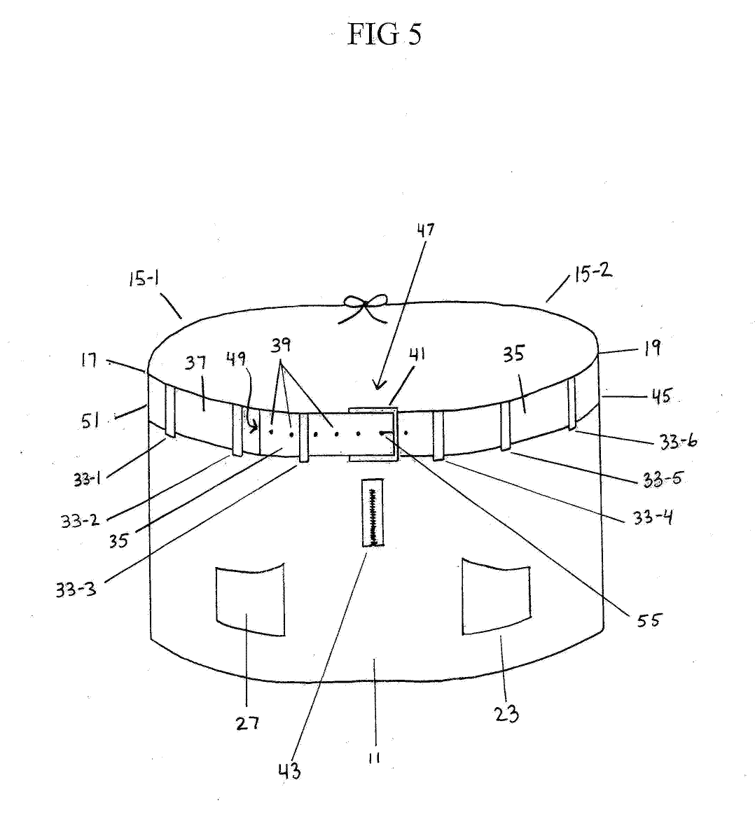

FIG. 5 is an anterior view of the present embodiment. In this view it can be seen that the apron strings 15-1 and 15-2 are tied on the posterior side of the main panel 11. This is how the anterior side of the dressing device would appear while worn on a body when looking at the anterior side of the person's body.

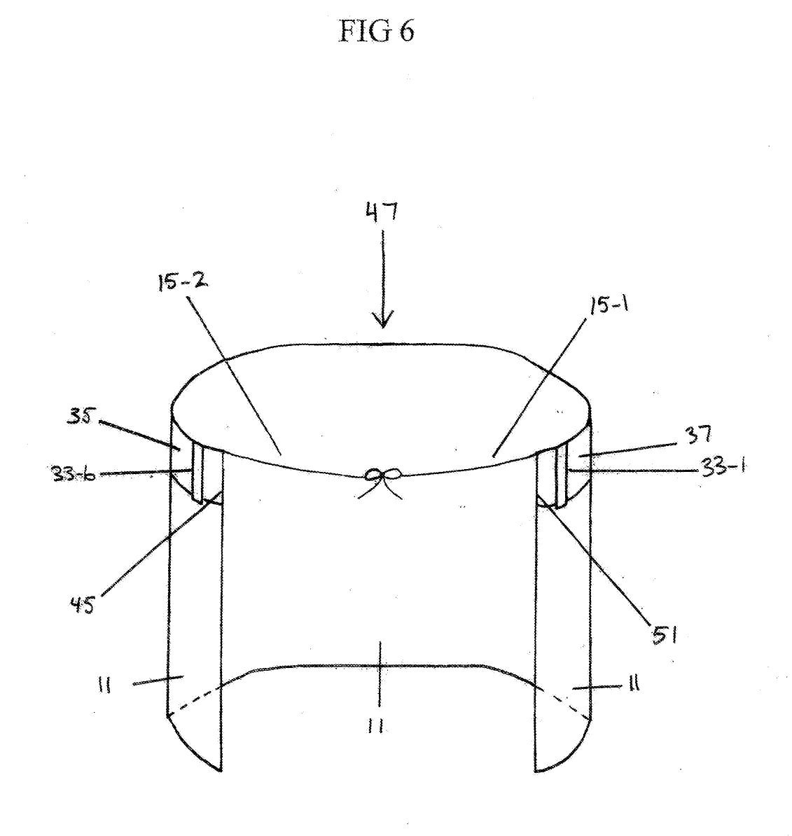

FIG. 6 is a posterior view of the present embodiment. In this view it can be seen that the posterior side of the main panel 11 does not comprise any clothing fasteners. Rather, the clothing fasteners are located on the anterior side of the main panel 11. In this view it can be seen that the apron strings 15-1 and 15-2 are tied on the posterior side of the main panel 11. This is how the posterior side of the dressing device would appear while worn on a body when looking at the posterior side of the person's body.

Thus the reader will see that the present embodiment comprises clothing fasteners that are positioned on the main panel 11 with the purpose of simulating a lower body article of clothing; thereby providing children and adults with special needs the opportunity to learn to manipulate clothing fasteners on a wearable dressing device. This will enable the learner to generalize the acquired dressing skills to actual lower body clothing items while those clothing items are worn on the body.

It should be noted that the present embodiment is not limited to the particular number and/or arrangement of fastening elements set forth above. Rather, it is to be understood that the number and/or arrangement of fastening elements could be modified without departing from the spirit of the present invention. It should also be noted that the present embodiment is not limited to the particular types of fastening elements set forth above. Rather, it is to be understood that additional types of fastening elements (e.g. snaps, Velcro, drawstring, hook and eye closure, etc) could be incorporated into the present embodiment without departing from the spirit of the present embodiment.

I claim:

1. A dressing device for teaching children and adults with special needs to fasten and unfasten at least 1 clothing fastener that is positioned at the waist, comprising:
(a) a main panel of a predetermined size and shape,
(b) a plurality of apron strings; affixed to the right upper corner of said main panel and the left upper corner of said main panel,
(c) said clothing fastener affixed to said main panel in a position that resembles the orientation of said clothing fastener on an article of clothing that fastens at the waist,
(d) means for attaching said apron strings to said main panel,
(e) means for attaching said clothing fastener to said main panel,
whereby said population can wear said dressing device around their waist in order to learn to fasten and unfasten said clothing fastener that is found on clothing items that fasten at the waist.

2. The dressing device in claim 1 wherein said dressing device resembles an apron.

3. The apron strings in claim 1 wherein said apron strings are of a predetermined length.

4. The main panel in claim 1 wherein said main panel is rectangular in nature.

5. The main panel in claim 4 wherein said main panel comprises a button and a corresponding button flap of a predetermined size affixed to a top side of said main panel at midline.

6. The button flap in claim 5 wherein said button flap further comprises a button hole positioned horizontally.

7. The button flap in claim 6 wherein said button flap is rectangular in nature.

8. The button flap in claim 7 wherein said button flap is affixed to said main panel adjacent to and to the left of said button.

9. The button flap in claim 8 wherein said button flap is affixed to said main panel on 1 side so that it can be placed over said button with means to be buttoned and unbuttoned.

10. The main panel in claim 4 wherein said main panel comprises a zipper of a predetermined size positioned vertically and directly underneath said button.

11. The main panel in claim 4 wherein said main panel comprises a plurality of belt loops spaced evenly apart and positioned vertically along said top side of said main panel.

12. The main panel in claim 4 wherein said main panel comprises a left side belt of a predetermined length and width.

13. The left side belt in claim 12 wherein said left side belt further comprises a plurality of belt buckle holes spaced evenly apart and located at the distal end of said left side belt.

14. The left side belt in claim 12 wherein the proximal side of said left side belt is affixed to a top left side edge of said main panel.

15. The main panel in claim 4 wherein said main panel comprises a right side belt of a predetermined length and width.

16. The right side belt in claim 15 wherein said right side belt further comprises a belt buckle with a prong, affixed to the distal end of said right side belt.

17. The right side belt in claim 15 wherein the proximal end of said right side belt is affixed to a top right side edge of said main panel.

18. The main panel in claim 4 wherein said main panel comprises a plurality of pockets of a predetermined size.

19. The clothing fastener in claim 1 wherein said clothing fastener differs in color from said main panel.

20. The clothing fastener in claim 1 wherein said clothing fastener includes any possible combination of 5, 10, 11, 12, 15 and 18.
